(19) United States
(12) Patent Application Publication
(10) Pub. No.: US 2008/0070783 A1
(43) Pub. Date: Mar. 20, 2008

(54) Effervescent tablet comprising a colorant

(76) Inventor: Jan Overwater, De Kwakel (NL)

Correspondence Address: TRASK BRITT, P.O. BOX 2550, SALT LAKE CITY, UT, 84110, US

(21) Appl. No.: 11/897,458

(22) Filed: Aug. 29, 2007

Related U.S. Application Data
(63) Continuation of application No. PCT/EP2005/055744, filed on Nov. 4, 2005.
(63) Continuation-in-part of application No. 11/076,413, filed on Mar. 9, 2005.

(30) Foreign Application Priority Data
Nov. 4, 2005 (EP) EP04105531.0
Mar. 7, 2005 (EP) EP05101738.2

(51) Int. Cl. A01N 3/02

(52) U.S. Cl. 504/114

(57) ABSTRACT

An effervescent tablet includes an organic acid, an alkali metal or earth alkali metal hydrogen carbonate, and a colorant for decorative use. The tablet may also include at least one of an aromatic substance and a nutrient for plants or flowers. The tablet may be added to water to give color to water, such as water for cut flowers. A combination of such a tablet and cut flowers is also disclosed.

### CROSS-REFERENCE TO RELATED APPLICATIONS

This application is a continuation of PCT International Patent Application PCT/EP2005/055744, filed on Nov. 4, 2005, designating the United States of America and published in English, which claims priority to prior European patent application EP 04105531.0, filed on Nov. 11, 2004, to prior European patent application EP 05101738.2, filed on Mar. 7, 2005, and to prior U.S. application Ser. No. 11/076,413, filed on Mar. 9, 2005, the contents of each of which are hereby incorporated herein, in their entirety, by this reference. This application is also a continuation-in-part of U.S. application Ser. No. 11/076,413, filed on Mar. 9, 2005, which claims the benefit of priority under 35 U.S.C. § 119 to prior European patent application EP 04105531.0, filed on Nov. 4, 2004.

### FIELD OF INVENTION

The invention relates to an effervescent tablet comprising a colorant. More particularly, the invention relates to a method for giving color to water which is used for cut flowers. The invention also pertains to a combination of cut flowers and said tablet.

### BACKGROUND OF RELATED ART

Effervescent tablets as such are known. For instance, in British patent application GB 1075470, effervescent tablets which contain at least one test reagent or diagnostic agent to be dispersed in an aqueous liquid comprise a core and at least one covering layer, each containing a water-soluble dye are described. This relates to test reagent or diagnostic agent and is, therefore, related to a completely different field and use.

In FR 2628734, soluble fertilizers in a tablet form are disclosed, containing nutrient materials and an effervescence agent, which causes the tablet to bubble and dissolve in water. The tablets may also contain a dye to give an instant indication that the fertilizer has been added to the water. These tablets, thus, serve another purpose, i.e., they are not decorative, but are used as an indicator for releasing a measured amount of fertilizing material into a garden.

In CA 2122873, an effervescent tablet is formed which contains a carbonate, an organic acid, at least one dye, a solubilizing agent, and a binder. The tablet, which is non-toxic, can be dissolved in water so that a dye is released that can be used to dye Easter eggs. This tablet also serves a different purpose and is used in a different field.

The closest prior art of which the applicant is aware is British patent application GB 1442979, which discloses a composition for keeping flowers fresh. This composition is in the form of an effervescent tablet that comprises one or more nutrients for keeping flowers fresh. These tablets do not contain colorants or dyes.

Accordingly, there are needs for methods and compositions to provide a color to the water for decorative purposes, and, more particularly, to provide a color to the water of cut flowers and, optionally, to give nutrients to the water of cut flowers, or to provide an odor to the environment.

### SUMMARY OF THE INVENTION

In its broadest concept, the invention relates to an effervescent tablet comprising an organic acid, an alkali metal or earth alkali metal hydrogen carbonate, and a colorant for decorative use. More particularly, the invention relates to such tablets further comprising at least one of an aromatic substance and a nutrient for plants or flowers.

The invention further provides a method for providing water with a color, for instance, water in a bowl or the like. More particularly, the water is water for flowers, such as water in a vase. It is further commercially attractive to provide a combination of cut flowers and a tablet of the invention which can be used as such by the consumer. The tablet may, for that purpose, be attached to a label that can be provided together with the flowers or plant.

### DETAILED DESCRIPTION

The effervescent tablet may be any effervescent tablet that is known in the art and that dissolves sufficiently fast. The production of effervescent tablets from, for instance, bicarbonates and solid organic carboxylic acids is known, but not in combination with the other components mentioned above with the purpose of providing a composition for giving water for flowers a color. Further advantages are the easy handling and, as a result of the effervescent effect, the ability to dissolve rapidly, as well as a good mixing and, thus, a rapid effectiveness of the active components of the effervescent tablet composition according to the present invention. The tablet may be coated, for instance, with a cellulose derivative such as hydroxypropyl methylcellulose. Coated tablets have the advantage of preventing the preliminary release of the colorant and further improve the resistance against humidity.

The following ingredients are mentioned merely by way of example and should not be interpreted restrictively.

A suitable composition for the tablet of the invention may comprise one or more of the following components (expressed in wt. % based on the total weight of the mixture):
Optionally, a plant nutrient, for instance, a sugar such as glucose and/or dextrose, in an amount of 0 to 96 wt. % (e.g., 35 to 75 wt. %);
Optionally, a surfactant, which may be present in an amount of 1 to 4 wt. %;
Optionally, a bactericide for inhibiting or killing bacteria in the water for the flowers, which may be included in an amount of 1 to 5 wt. %;
An organic carboxylic acid, such as an organic dicarboxylic acid (e.g., succinic acid, tartaric acid, etc.), which may be include in an amount of 5 to 40 wt. % (e.g., 10 to 26 wt. %);
An alkali metal or earth alkali metal hydrogen carbonate, which may be present in an amount of 6 to 40 wt. % (e.g., 15 to 30 wt. %). The alkali metal, particularly sodium or potassium, hydrogen carbonates are preferred.

The above mixture can be varied, but at least contains the organic carboxylic acid, the hydrogen carbonate, and the colorant. This mixture forms the basis for making an effervescent tablet that is suitable for giving a color to water. It is, therefore also an objective to provide a mixture that is suitable as a basis for making an effervescent tablet, which mixture as such is already able to give color to water, and which mixture at least comprising a colorant can be used for giving color to water for use with cut flowers.

The organic carboxylic acid may be in its anhydrous form. It was found that the use of anhydrous organic carboxylic acids substantially increases the stability of the effervescent tablet. Such tablets are not hygroscopic and can be stored and sold without the need for special water-impermeable packaging. Suitable anhydrous organic carboxylic acids include, but are not restricted to, citric acid, oxalic acid, pyruvic acid, malic acid, malonic acid, succinic acid, glutaric acid, adipic acid, gluconic acid, lactic acid, tartaric acid, and mixtures thereof. Organic dicarboxylic acids are more preferred, and most preferred are anhydrous hydroxy dicarboxylic acids, such as anhydrous tartaric acid.

The mixture may further comprise a thickening agent, such as polyethylene glycol (for instance PEG 6000, Na stearyl-fumarate, and the like) for preventing sticking.

The nutrient may be any common nutrient for use in flowers and plants, and may contain a sugar or a mixture of sugars, such as glucose, dextrose, and the like.

The mixture may contain common bactericides and fungicides, such as a quaternary ammonium compound, containing an alkyl radical; for example, one of the following BARQUAT® MS-100 (myristyl dimethyl benzyl ammonium chloride dihydrate), BARDAC® 22 (didecyl dimethyl ammonium chloride), BARDAC® 20 (a mixture of 50%, by weight, octyl decyl dimethyl ammonium chloride; 25%, by weight, dioctyl dimethyl ammonium chloride and 25% by weight didecyl dimethyl ammonium chloride).

The tablet further includes a colorant. The colorant may be any colorant that does not harm the flowers. In principle, almost any colorant can be used in quantities sufficient to give the desired color intensity. Suitable amounts are 0.1 to 10 wt. %, more preferably 0.5 to 5 wt. %. Suitable colorants include, but are not limited to, ecoline pigments, food pigments (E dyes), acid pigments, metal complex acid dyes, basic dyes, chrome dyes, disperse dyes, solvent dyes, direct dyes, phthalates fast dyes, naphthol dyes, reactive dyes, such as pigment emulsion dyes, fast color salts dyes, rapid fast dyes, aluminum lake color (pigments) wet dyes, natural dyes, and the like.

The tablet may contain other components, such as potassium chloride (1 to 5 wt. %), aluminum sulfate (1 to 5 wt. %), and the like.

The tablet may contain aromatic compounds such as ethereal oils, hesperides, air freshener, and the like, such as, for instance, one or more of the oils: rose Sonia, rose Tros, freesia, carnation, lily-of-the-valley, lilac, floral bouquet, sweet freesia, rose fruity, banana sweet, and cinnamon.

In a specific example according to the invention, the following mixture for an effervescent tablet was made:

| | |
|---|---|
| Flower Food Clear ® (Plant nutrient mix) | 56 wt. % |
| tartaric acid | 14.8 wt. % |
| NaHCO₃ | 26.3 wt. % |
| PEG 6000 | 2.9 wt. % |

To this mixture, 1 wt. % of Tartrazine E-120 (a colorant), based on the weight of the mixture was added, i.e., to 495 grams of the above mixture, 5 grams of colorant were added.

The above tablets are particularly suitable for small-scale production. However, apparatus for manufacturing such tablets on a large-scale may clog during production. Therefore, the present invention also includes mixtures that are better suited for large-scale production, and which nevertheless have the advantageous properties of the previous tablets, giving color to water for use with cut flowers, without being detrimental to the flower or plant. It was found that the presence of salt (sodium chloride) (e.g., anhydrous salt) provides mixtures that are particularly suitable for large-scale production. A non-limitative example of such tablet is a tablet obtained from the following mixture (in wt. %):

| | |
|---|---|
| Sodium chloride salt PDV* | 45.51 |
| Dissolvine Na2 (Na₂EDTA) | 5.68 |
| PVP-iodine | 1.71 |
| Lutrol F68 | 2.12 |
| L-Leucine | 2.12 |
| KHCO₃ anhydrous | 23.28 |
| Adipic acid | 19.58 |
| Silver nitrate | 0.004 |

(*PDV = pure vacuum dried)

To this mixture, 1 to 5 wt. % of a colorant, based on the weight of this mixture, was added.

The tablets may comprise 25 to 60 wt. % of salt, and to a total of 3 to 20 wt. % of solubilizers (such as chelating agents, including EDTA an the like, and viscosity modifiers (thickening agents) such as polyethylene glycols). It was also found that an aseptic compound, such as PVP-iodine (povidone iodine), silver nitrate, and the like, or mixtures thereof could advantageously added to prevent microbiocidal contamination. Suitable amounts of aseptic compound are 0.5 to 15 wt. %. The other ingredients, such as colorant, organic acid, and alkali metal or earth alkali metal hydrogen carbonate are added in the amounts previously mentioned.

Suitable tablets have a total weight of 0.5 to 10 grams, more preferably 1 to 5 grams, most preferably about 3 to 4 grams. Sizes of the tablet are not important but usually are 5 to 100 mm, more preferably 15 to 30 mm, for instance 20 or 23 mm.

Although the foregoing description contains many specifics, these should not be construed as limiting the scope of the present invention, but merely as providing illustrations of some of the presently preferred embodiments. Similarly, other embodiments of the invention may be devised which do not depart from the spirit or scope of the present invention. Features from different embodiments may be employed in combination. The scope of the invention is, therefore, indicated and limited only by the appended claims and their legal equivalents, rather than by the foregoing description. All additions, deletions and modifications to the invention as disclosed herein which fall within the meaning and scope of the claims are to be embraced thereby.

What is claimed:

1. An effervescent tablet comprising an organic acid, an alkali metal or earth alkali metal hydrogen carbonate, and a colorant for decorative use.

2. The tablet of claim 1, wherein the organic acid is anhydrous.

3. The tablet of claim 2, further comprising 25-60 wt. % sodium chloride.

4. The tablet of claim 2, further comprising at least one of an aromatic substance and nutrient for plants or flowers.

5. The tablet of claim 4, further comprising 25-60 wt. % sodium chloride.

6. The tablet of claim 1, further comprising 25-60 wt. % sodium chloride.

7. The tablet of claim 1, further comprising at least one of an aromatic substance and nutrient for plants or flowers.

8. Use of a mixture comprising at least a colorant, for giving color to water for use with cut flowers.

9. A method for giving color to water for use with cut flowers by adding a tablet comprising an organic acid, an alkali metal or earth alkali metal hydrogen carbonate, and a colorant for decorative use to the water.

10. The method of claim 9, wherein the organic acid is anhydrous.

11. The method of claim 9, wherein the tablet further comprises 25-60 wt. % sodium chloride.

12. The method of claim 9, wherein the tablet further comprises at least one of an aromatic substance and nutrient for plants or flowers.

13. In combination, cut flowers and a tablet including an organic acid, an alkali metal or earth alkali metal hydrogen carbonate, and a colorant for decorative use.

14. The combination of claim 13, wherein the organic acid is anhydrous.

15. The combination of claim 13, wherein the tablet further comprises 25-60 wt. % sodium chloride.

16. The combination of claim 13, wherein the tablet further comprises at least one of an aromatic substance and nutrient for plants or flowers.
